(19) United States
(12) Patent Application Publication
(10) Pub. No.: US 2005/0213004 A1
(43) Pub. Date: Sep. 29, 2005

(54) Semi-transmission type liquid crystal display device and method of manufacturing the same

(75) Inventors: Michiaki Sakamoto, Kanagawa (JP); Kenichiro Naka, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/086,207

(22) Filed: Mar. 23, 2005

(30) Foreign Application Priority Data
Mar. 25, 2004 (JP) 2004-089751

(51) Int. Cl. G02F 1/1335

(52) U.S. Cl. 349/114

(57) ABSTRACT

In a semi-transmission type liquid crystal display device, a source electrode of a TFT in a reflection area of an active matrix substrate is used also as a reflection film, and a transparent electrode film in a transmission area is provided so as to extend onto a surface of a convex-shaped transparent organic film on the TFT, and electrically connected to the source electrode through a contact hole. An opposite electrode of an opposite substrate is made of the same material as the transmission electrode film. Thus, occurrence of flickers due to a residual DC voltage is suppressed.

### BACKGROUND OF THE INVENTION

1. Field of the Invention

The present invention relates to a liquid crystal display device and a method of manufacturing the same, and more particularly to a semi-transmission type liquid crystal display device having a transmission area and a reflection area in a pixel, and a method of manufacturing the same.

2. Descriptions of the Related Art

Liquid crystal display devices have been put into practical uses in a wide field starting with a cellular phone and a personal digital assistance (PDA) because of their compact size, thin thickness and low power consumption. As to the liquid crystal display devices, two driving methods including an active matrix method and a passive matrix method have been known. Since the active matrix method can display a high quality image, the active matrix method is widely adopted ordinarily.

Liquid crystal display devices driven by the active matrix method are classified into a transmission type and a reflection type. Any of the transmission type liquid crystal display devices and reflection type liquid crystal display devices fundamentally displays an image in such a manner that a liquid crystal panel operates as an electronic shutter to allow the light incident from the outside to transmit through or to shut off. Specifically, the liquid crystal display devices have no capability to emit light by themselves. Accordingly, when the liquid crystal display devices display an image, either type of the liquid crystal display devices requires a light source separately. For example, the transmission type liquid crystal display device is provided with a light source constituted by a backlight located on a plane opposite to a plane of a liquid crystal panel thereof displaying the image. Then, by switching between transmission and shut off of the light incident from the backlight of the liquid crystal panel, displaying is controlled. Such a transmission type liquid crystal display device allows the light from the backlight to be always incident onto the liquid crystal panel, whereby a bright image can be always obtained irrespective of the brightness of a place where the liquid crystal display device is used.

However, consumption power of a backlight light source is generally large, and nearly one half of the power of the transmission type liquid crystal display device is consumed by the backlight light source. Particularly, transmission type liquid crystal display device driven by a battery shows a short usable time. When a large sized battery is built in the transmission type liquid crystal display device in order to lengthen the usable time, weight thereof becomes larger, resulting in hindering a compact size and a light weight thereof.

Accordingly, in order to solve the problem of the power consumption of the backlight light source in the transmission type liquid crystal display device, a reflection type liquid crystal display device which requires no backlight light source has been proposed. The reflection type liquid crystal display device utilizes light (hereinafter referred to as external surrounding light) as a light source, which exists around the place where it is used. This reflection type liquid crystal display device provides a reflection plate inside its liquid crystal panel. In the reflection type liquid crystal display device, displaying is controlled by switching between transmission and shut off of the external peripheral light which is incident onto the inside of the liquid crystal panel and reflected by the reflection plate. Since the reflection type liquid crystal display device requires no backlight light source unlike in the case of the transmission type liquid crystal display device, it is possible to achieve a reduction of consumption power, a compact size and a lightweight thereof. However, since the external peripheral light does not function fully as a light source when the surroundings of the reflection type liquid crystal display device are dark, the reflection type liquid crystal display device has a problem that its visibility is significantly deteriorated.

As described above, the transmission type liquid crystal display device and the reflection type liquid crystal display device have respectively both merits and demerits, and therefore it is difficult to obtain stable displaying corresponding to external light. Accordingly, a semi-transmission type liquid crystal display device has been proposed in Japanese Patent Laid-Open Nos. 2003-156756 and 2003-050389 so that consumption power of a backlight light source is suppressed and visibility is improved even when external surrounding light is dark. The semi-transmission type liquid crystal display device comprises a transmission area and a reflection area in a pixel region of a liquid crystal panel, and is constituted so as to realize operations as the transmission and reflection type liquid crystal display devices by one liquid crystal panel.

According to the above described semi-transmission type liquid crystal display device, the semi-transmission type liquid crystal display device operates as a transmission-type liquid crystal display device by turning on the backlight to utilize the above described transmission area when the external peripheral light is dark. Even when the surroundings of the semi-transmission type liquid crystal display device are dark, it can exercise characteristics of the transmission type liquid crystal display device, that is, an increase in visibility. On the other hand, the external peripheral light is sufficiently bright, the semi-transmission type liquid crystal display device turns off the backlight and operates as the reflection type liquid crystal display device by utilizing the reflection plate. Thus, when the external surrounding light is sufficiently bright, the semi-transmission type liquid crystal display device can exercise characteristics of the reflection type liquid crystal display device, that is, lower consumption power.

In this semi-transmission type liquid crystal display device, incidence light from the backlight is allowed to transmit through a transmission layer in the transmission area to operate the semi-transmission type liquid crystal display device as the transmission type liquid crystal display device. On the other hand, in the reflection area to operate the semi-transmission type liquid crystal display device as the reflection type liquid crystal display device, incidence light, which is the external surrounding light, transmits through a liquid crystal layer of a liquid crystal panel in both ways. As a result, an optical path difference between both of the incidence lights in the liquid crystal layer is generated. Therefore, in the semi-transmission type liquid crystal display device, a reflection gap value of the reflection area, which is a thickness of the liquid crystal layer, and a transmission gap value of the transmission area need to be set to an optimum value in accordance with a twist angle of liquid crystal. With such a structure, an intensity of emission light emitted from a displaying plane can be optimized by difference of a retardation between the reflection and transmission areas.

FIG. 1 is a diagram schematically showing a constitution of the semi-transmission type liquid crystal display device having the transmission and reflection areas disclosed in Japanese Patent Laid-Open No. 2003-050389. As shown in FIG. 1, the semi-transmission type liquid crystal display device comprises an active matrix substrate 112, an opposite substrate 116 and a liquid crystal layer 117 held so as to be sandwiched by the active matrix substrate-112 and the opposite substrate 116 Furthermore, the display device comprises a backlight light source 118 on a rear plane side of the active matrix substrate 112, phase difference plates (λ/4 plate) 120A and 120B, and polarization plates 119A and 119B outside the active matrix substrate 112 and the opposite substrate 116, respectively. Herein, a transparent electrode film 105 and a reflection film 106 (reflection electrode) are provided on a plane of the active matrix substrate 112 opposite to the opposite substrate 116. The transparent electrode film 105 functions as a transmission area of a pixel electrode, and the reflection film 106 (reflection electrode) functions as a reflection area. By the semi-transmission type liquid crystal display device constituted by arranging the optical members alternately as described above, optimization of an intensity of emission light can be achieved by controlling a polarization state of incidence light and emission light. Note that reference symbols DR and DF of FIG. 1 denote a reflection gap value of the reflection area, which is a thickness of a liquid crystal layer, and a transmission gap value of the transmission area respectively. Among numeric values illustrated at the right extremity of FIG. 1, “Φ° ” represents a twist angle of liquid crystal, and “45 represents an arrangement angle of an optical axis of the phase difference plate (λ/4) relative to an optical axis of the polarization plate 119B. Furthermore, “135°” represents an arrangement angle of an optical angle of the phase-difference plate 120A relative to the optical axis of the polarization plate 119B. “90°” represents an arrangement angle of an optical angle of the polarization plate 119A relative to the optical axis of the polarization plate 119B. The numeric value representation of 0” for the opposite substrate 116 means that a longer side of the opposite substrate 116 is arranged in parallel with the optical axis of the polarization plate 119B.

Next, referring to FIG. 2, a constitution of a liquid crystal panel of a conventional semi-transmission type liquid crystal display device will be described. The semi-transmission type liquid crystal panel, as shown in FIG. 2, comprises an active matrix substrate 112 in which a thin film transistor (TFT) operating as a switching element is formed, an opposite substrate 116, and a liquid crystal layer 117 held so as to be sandwiched by both substrates. Herein, the active matrix substrate 112 includes a transparent insulating substrate 60, a gate line (not shown) formed on the transparent insulating substrate 60, a data line (not shown) formed thereon, a gate electrode 61 connected to the gate line, a gate insulating film 63 and a semiconductor layer 64. Furthermore, the active matrix substrate 112 includes drain and source electrodes 65 and 66 formed so as to be respectively extended from both ends of the semiconductor layer 64 to be connected to the data line and a pixel electrode, and a passivation film 67. Note that reference numeral 62 of FIG. 2 denotes an auxiliary capacity electrode.

A pixel region 200 is divided into a transmission area 202 which allows incidence light from a backlight light source 118 to transmit through, and a reflection area 201 which reflects external peripheral light incident thereonto. On a passivation film 67 of the transmission area 202, a transparent electrode film 68 made of indium tin oxide (ITO) is formed. The transparent electrode film 68 of the reflection area 201 is connected to a reflection film 71 containing Al or Al alloy, which is formed on an irregularity surface of an organic film 70 or the like. The transparent electrode film 68 and the reflection film 71 are connected to the source electrode 66 through a contact hole 69 formed in the passivation film 67. The transparent electrode film 68 and the reflection film 71 function as a pixel electrode. An alignment film (not shown) is formed on these electrode films.

Herein, a TFT is constituted by the gate electrode 61, the gate insulating film 63, the semiconductor layer 64, the drain electrode 65 and the source electrode 66. On the other hand, the opposite substrate 116 includes a transparent insulating substrate 90, a color filter 91, a black matrix (not shown), an opposite electrode 92 and an alignment film (not shown).

In the semi-transmission type liquid crystal display device having such a structure, in the transmission area 202, backlight light, which is emitted from the backlight light source 118 and incident onto from a rear plane of the active matrix substrate 112, passes through the liquid crystal layer 117, and is emitted from the opposite substrate 116. Then, in the reflection area 201, external surrounding light incident from the opposite substrate 116 passes through the liquid crystal layer 117, and thereafter is reflected by the reflection film 71. The reflected light passes through the liquid crystal layer 117 again, and is emitted from the opposite substrate 116. A step difference of an irregularity film which means an organic layer 70 having an irregularity plane is designed so that the reflection gap DR is about half of the transmission gap DF. Note that this case is an example that the twist angle Φ is approximately equal to zero degree. As described above, by designing the reflection gap DR and the transmission gap DF, optical pass lengths between both incidence lights passing through the respective areas become almost equal to each other, and a polarization state of the emission light is adjusted.

Next, referring to FIG. 3, an example of a method of fabricating the conventional semi-transmission liquid crystal display device disclosed in Japanese Patent Laid-Open Nos. 2003-156756 and 2003-050389 described above will be described in the order of processes. First, as shown in FIG. 3A, a metallic film made of Al—Nd, Cr or the like is deposited entirely on the transparent insulating substrate 60 such a glass substrate. This metallic film is patterned by a photolithography technique and an etching technique, and thus the gate line, the gate electrode 61, a common storage line and the auxiliary capacity electrode 62 are formed (first photolithography step, hereinafter referred to as First PR).

Next, as shown FIG. 3B, a gate insulating film 63 such as SiO₂, SiNₓ and SiOₓ is formed entirely on the transparent insulating substrate 60. Subsequently, a semiconductor film such as an amorphous silicon (a-Si) film is entirely on the transparent insulating substrate 60 by a plasma chemical vapor deposition method. This semiconductor film is patterned, and thus the semiconductor layer 64 of the TFT is formed (Second PR).

Subsequently, as shown in FIG. 3C, a metallic film made of Cr or the like is deposited on the entire surface of the transparent insulating substrate 60. This metallic film is patterned, and thus the data line, the drain electrode 65 and the source electrode 66 are formed (Third PR). In the above described manner, the TFT is formed.

Thereafter, as shown in FIG. 3D, after the passivation film 67 formed of a SiNₓ film or the like is deposited on the entire surface of the transparent insulating substrate 60 in order to protect the TFT, the contact hole 69 for connecting the pixel electrode and the TFT is opened (Fourth PR).

Next, as shown in FIG. 3E, a transparent conductive film made of ITO or the like is deposited on the entire surface of the transparent insulating substrate 60 by a sputtering method. This transparent conductive film is patterned, and the transparent electrode film 68 is formed so as to cover the entire surface of each pixel (Fifth PR).

Subsequently, as shown in FIG. 3F, a photosensitive acrylic resin is coated onto the passivation film 67 and the transparent electrode film 68 by a spin coating method, whereby the film 70 having a concavo-convex surface on a front face is provided is formed in the reflection area of the pixel region. When the incidence light, which is the external surrounding light, is reflected by a reflection film to be described later, the film 70 is formed in order to improve visibility of this reflection light. Furthermore, when the film 70 made of the photosensitive acrylic resin is formed, concave portions thereof are exposed by a comparatively small amount of light. On the other hand, convex portions are kept not to be exposed, and an area where the contact hole is to be formed is exposed by a comparatively large amount of light. In order to perform such exposure, for example, the reflection film is used as a mask for portions corresponding to the convex portions, and the transmission film is used as a mask for a portion thereof corresponding to the contact hole. A halftone (gray tone) mask in which a semi-transmission film is formed is used for portions corresponding to the concave portions. By use of such a halftone mask, a concavo-convex surface is formed on the front face of the film 70 by one exposure. Note that the concavo-convex surface can be formed also by separately exposing the contact hole portion and the concave formation portion by use of a mask composed of an ordinary reflection and transmission areas alone, instead by use of the halftone mask. Thereafter, by use of alkali developer, the concavo-convex surface is formed by use of difference of solution rates among the concave portions, the convex portions and the contact hole (Sixth PR).

Next, as shown in FIG. 3G, Mo and Al are continuously deposited on the entire surface of the transparent insulating substrate 60 by use of a sputtering method or a deposition method, and thus a metallic film for the pixel electrode is formed. After a portion of this metallic film which is the reflection area is covered with a resist pattern, the exposed metallic film (Mo/Al) is either dry-etched or wet-etched, and thus the reflection film 71 is formed (Seventh PR). Herein, Mo is used as a barrier metal for preventing Al as the reflection film and ITO as the pixel electrode from causing an electrolytic corrosion at the development process as a result of a direct contact of Al and ITO. Since Al and Mo can be etched by the same wet etching, the number of processes never increases. Accordingly, Mo is preferred as the barrier metal.

Thereafter, an alignment film made of polyimide (not shown), which covers the transparent electrode film 68, the reflection film 71 and the film 70 having the concavo-convex surface on its front face, is formed, and thus the active matrix substrate 112 is fabricated.

Subsequently, as shown in FIG. 2, the opposite substrate 116, which is constituted by sequentially forming the color filter 91, the black matrix, the opposite electrode 92, the alignment film and the like on the transparent insulating substrate 90, is prepared. Then, the liquid crystal layer 117 is interposed between both substrates. On each external side of both substrates, the phase difference plates (λ/4) 120A and 120B and the polarization plates 119A and 119B are arranged. On one of the planes of the polarization plate 119A opposite to the plane thereof facing the active matrix substrate 112, the backlight light source 118 is disposed, and thus the semi-transparent liquid crystal display device is fabricated.

As described above, with respect to the conventional semi-transmission type liquid crystal display device, the formation process of the film having a concavo-convex surface on its front surface in the reflection area of the pixel region and the formation process of the reflection film thereof are additionally performed in comparison with the transmission type liquid crystal display device, and the number of the photolithography processes (PR) is 7 PR, resulting in an increase of manufacturing cost.

Since Al as the reflection electrode and ITO as the opposite electrode are the different metals, a problem that a residual DC voltage (voltage due to residual charges) is caused in the reflection area and flickering is caused to arise. The problem of this residual DC voltage will be described in detail below.

The semi-transmission type liquid crystal display device driven by the active matrix method is ordinarily operated by AC voltage. By use of a voltage applied to the opposite electrode as a reference voltage, a voltage changing its polarity between plus and minus in every certain time period is supplied to the pixel electrode. With reference to the voltage applied to the liquid crystal, a positive voltage waveform and a negative voltage waveform should be symmetrical. However, if the AC voltage in which the plus and minus voltage waveforms are symmetrical is applied to the pixel electrode, unintended DC voltage components to be described later may remain in the waveform of the voltage actually applied to the liquid crystal, and thus the voltage applied to the liquid crystal has no plus and minus voltage waveforms symmetrical to each other. Therefore, a light transmission rate of the liquid crystal layer at the time when a plus voltage is applied and that thereof at the time when a minus voltage is applied differs from each other. Brightness of the semi-transmission type liquid crystal display device changes at a cycle of a AC voltage applied to the pixel electrode, and the blink called a flicker occurs. This flicker occurs due to alignment films respectively formed on the surfaces of the opposite substrate and the active matrix substrate disposed on both sides of the liquid crystal layer to alignment-control the liquid crystal molecules. Particularly, DC voltage components are generated when an electrode of the TFT substrate and an electrode of the opposite substrate are different from each other. This problem is essential one in the conventional semi-transmission structure in which the reflection film made of Al or the like is formed on the uppermost layer of the active matrix substrate and the alignment film made of polyimide is coated thereonto. A proposal of a structure for suppressing occurrence of the flicker due to this residual DC voltage has been long awaited.

### SUMMARY OF THE INVENTION

The present invention was invented in view of the foregoing circumstances, and an object of the present invention is to solve the problem in the conventional semi-transmission type liquid crystal display device in which the number of photolithography processes is larger compared to the transmission type liquid crystal display device. An object of the present invention is to provide a semi-transmission type liquid crystal device having a structure in which reflection light is fully visible under existence of external light, and a method of manufacturing the same. Furthermore, an object of the present invention is to provide a semi-transmission type liquid crystal display device capable of suppressing occurrence of flicker due to a residual DC voltage of a reflection film, and a method of manufacturing the same.

A semi-transmission type liquid crystal display device of the present invention comprises a first substrate, a second substrate arranged opposite to the first substrate, and a liquid crystal layer arranged between the first and second substrates. The first substrate includes a plurality of data lines and a plurality of gate lines intersecting on a first transparent insulating substrate, and TFTs operating as a switching element, which are provided near intersection points of the data and gate lines. The first substrate includes a reflection film in a pixel region surrounded by each data line and each gate line, a reflection area where the TFT is arranged, and a transmission area having a first transparent electrode film. The second substrate arranged opposite to the first substrate includes a second insulating transparent substrate.

The TFT provided in the first substrate is arranged in the reflection area, and has a semiconductor layer, a drain electrode connected to the data line and a source electrode having a function of the reflection film. A transparent organic film is formed so as to cover the TFT on the reflection area and to be convex-shaped. The first substrate includes a first transparent electrode film in the transmission area, which functions as a pixel electrode. The first transparent electrode film is provided so as to extend onto the transparent organic film in the reflection area, and is connected to the source electrode through a contact hole from a surface of the transparent organic film. A second transparent electrode film functioning as an opposite electrode is formed on the second insulating transparent substrate. This second transparent electrode film is made of the same material as the first transparent electrode film.

The semi-transparent type liquid crystal display device of the present invention can comprise a color filter layer either on the substrate of the first substrate side or under the first transparent electrode film of the first substrate. When the foregoing semi-transmission type liquid crystal display device of the present invention comprises the color filter layer under the first transparent electrode film of the first substrate, this semi-transmission type liquid crystal display device can comprise a color filter patterned so as to have a shape in the form of a line or a dotted shape in the transparent organic film of the transmission area.

The semi-transmission-type liquid crystal display device of the present invention can comprise a phase difference plate and a polarization plate respectively on surfaces of the first and second substrates in this order, which do not face the liquid crystal layer. Furthermore, the semi-transmission type liquid crystal display device of the present invention, which is described above, can comprise a light scattering layer between the second substrate and the phase difference plate formed on the surface of the second substrate. In addition the semi-transmission type liquid crystal display device of the present invention can comprise an optical path changing layer outside the polarization plate on the side of the second substrate.

The semi-transmission type liquid crystal display device of the present invention can use a metal selected out of Al, Al alloy, Ag and Ag alloy as a surface of the source electrode having a function of the reflection film.

The semi-transmission type liquid crystal display device of the present invention can provide the transparent organic film also on the data lines and the gate lines so as to cover them. Then, the first transparent electrode film is arranged on the transparent organic film on the data and gate lines so as, to be superposed on the data and gate lines.

The semi-transmission type liquid crystal display device of the present invention can provide the transparent organic film having the concavo-convex surface on the front surface their of in the reflection area. And the semi-transmission type liquid crystal display device of the present invention can allow a surface of the first transparent electrode film formed on the concavo-convex surface of the transparent organic film to have a reflection function to totally reflect light-incident thereonto.

In the semi-transmission type liquid crystal display device of the present invention, since the source electrode and the storage electrode serve as a reflection film, the number of the processes can be decreased by one compared to a photolithography processing of manufacturing an active matrix substrate of a conventional semi-transmission type liquid crystal display device, and the number of the photolithography processes is 6PR. Thus, it is possible to shorten the manufacturing processes, and to decrease costs.

In the semi-transmission type liquid crystal display device of the present invention, by using a predetermined optical path changing layer and a light scattering layer on the side of the opposite substrate, it is possible to suppress occurrence of phenomenon in which external light is incident onto a liquid crystal display screen to be reflected by a surface of a flat metallic electrode in a liquid crystal layer, which is a reflection member and also functions as the storage and source electrodes on the TFT substrate, and in which the reflected light is emitted onto the liquid crystal display panel to be seen thereon (hereinafter such phenomenon is referred to as “displaying of external light”). The flat metallic electrode serves also as a storage electrode and a source electrode of a TFT substrate and functions as a reflection plate.

In the semi-transmission type liquid crystal display device, irregularities having an average angle of inclination are provided in a surface of the transparent organic film of the TFT substrate. By providing a first transparent electrode film thereon, apart of light is reflected under a total refection condition by use of refractive indexes between an alignment film of polyimide and the first transparent electrode film, whereby it is possible to control the reflected light causing displaying of external light.

In the semi-transmission type liquid crystal display device of the present invention, a transparent organic film is provided also on gate and data lines. The first transparent electrode film such as ITO, which is a pixel electrode, is provided on the transparent organic film so as to be superposed on the wirings. By superposing the first transparent electrode film on the wirings, it is possible to shield unnecessary leakage light around the wirings. A black matrix which shields the unnecessary leakage light around the wirings needs not be provided on an opposite substrate, it is possible to increase an aperture ratio. Furthermore, since an area where the pixel electrode and the wirings are superposed functions also as, a reflection area, this area can be used effectively as the reflection area.

Furthermore, the first transparent electrode film made of the same material as ITO is formed on the reflection area and the transmission area of the first substrate, where TFTs are formed. Then, a second transparent electrode film, which is an opposite electrode of a second substrate formed opposite to the first substrate with a liquid crystal layer interposed therebetween, is also made of the same material as the first transparent electrode film. With this constitution, it is possible to suppress the occurrence of flickers due to a residual DC voltage.

In the semi-transmission type liquid crystal display device of the present invention, when a color filter is provided on the side of a first substrate in which TFTs are provided, a color filter layer randomly patterned to be minutely convex-shaped is provided in a transparent organic film in a reflection area. By coating a transparent organic film onto a base of the color filter layer, it is possible to easily form irregularities having a predetermined angle of inclination that can use ITO as a lens. Furthermore, since the color filter in the reflection area is perforated, an extreme decrease of a refractory index owing to that light passes trough the reflection area two times, and extreme gap from transmission light can be prevented.

### BRIEF DESCRIPTION OF THE DRAWINGS

The above and other objects, features and advantages of the present invention will be become more apparent from the following detailed description when taken in conjunction with the accompanying drawings wherein:

FIG. 1 is a view schematically showing a constitution of a semi-transmission type liquid crystal display device having a transmission area and a reflection area;

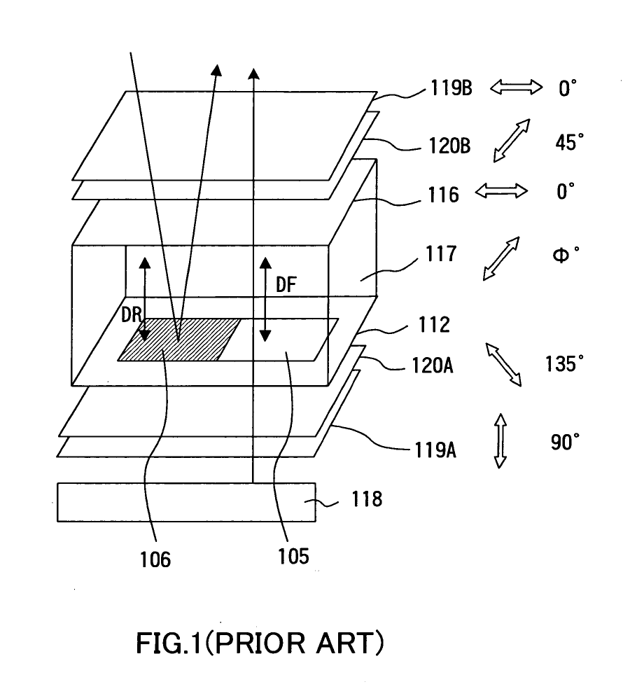

FIG. 2 is a section view showing a constitution a liquid crystal display panel of a conventional semi-transmission type liquid crystal display device;

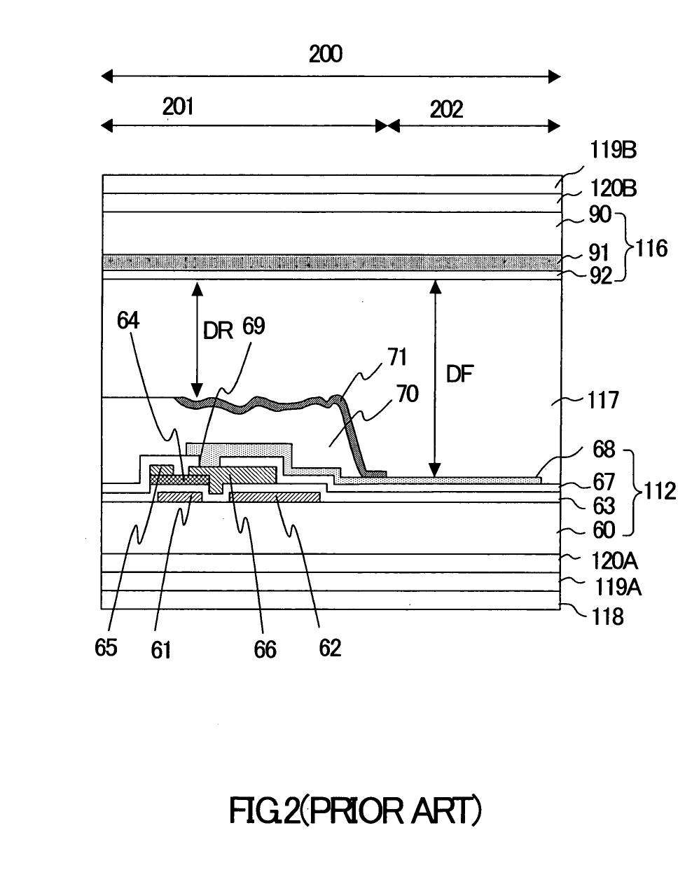

FIGS. 3A to 3G are section views of substantial parts for explaining a method of manufacturing the conventional semi-transmission type liquid crystal display device in the order of manufacturing processes;

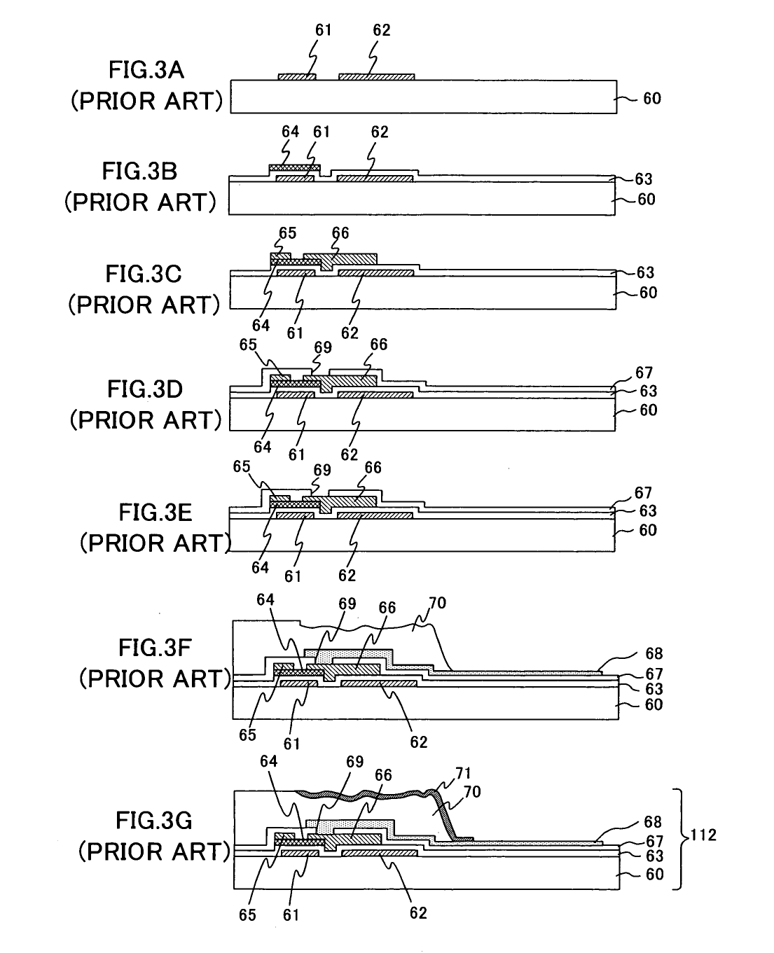

FIG. 4 is a diagram showing a relation among an average height of a transparent organic film on a TFT, a gap of a transparent area and a gap of a reflection area in the semi-transmission type liquid crystal display device;

FIG. 5 is a section view showing a constitution of a semi-transmission type liquid crystal display device of a first embodiment of the present invention;

FIG. 6 is a plan view showing the semi-transmission type liquid crystal display device of the present invention, which especially shows a constitution near a TFT;

FIGS. 7A and 7B are section views respectively taken along the lines I-I and II-II of FIG. 6;

FIGS. 8A to 8F are process diagrams showing a method of manufacturing the semi-transmission type liquid crystal display device of the first embodiment of the present invention in the order of manufacturing processes;

FIG. 9 is a section view showing a constitution of a semi-transmission type liquid crystal display device of a second embodiment of the present invention;

FIG. 10 is an enlarged view of a transparent organic film portion having an irregularity plane in FIG. 9; and

FIG. 11 is a section view showing a constitution of a semi-transmission type liquid crystal display device which is a third embodiment of the present invention.

### DETAILED DESCRIPTION OF THE PREFERRED EMBODIMENTS

### First Embodiment

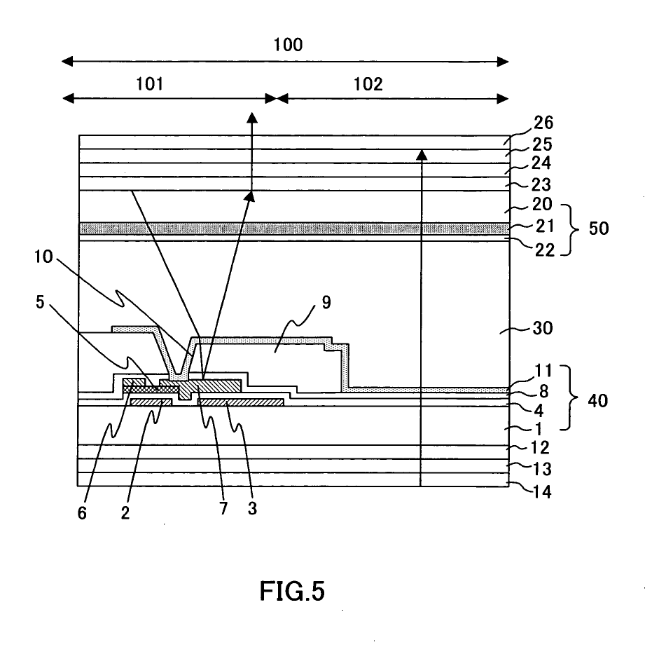

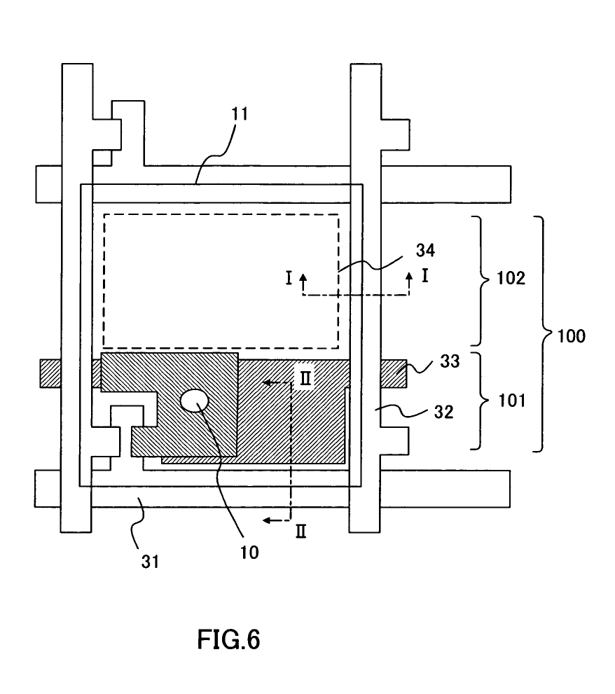

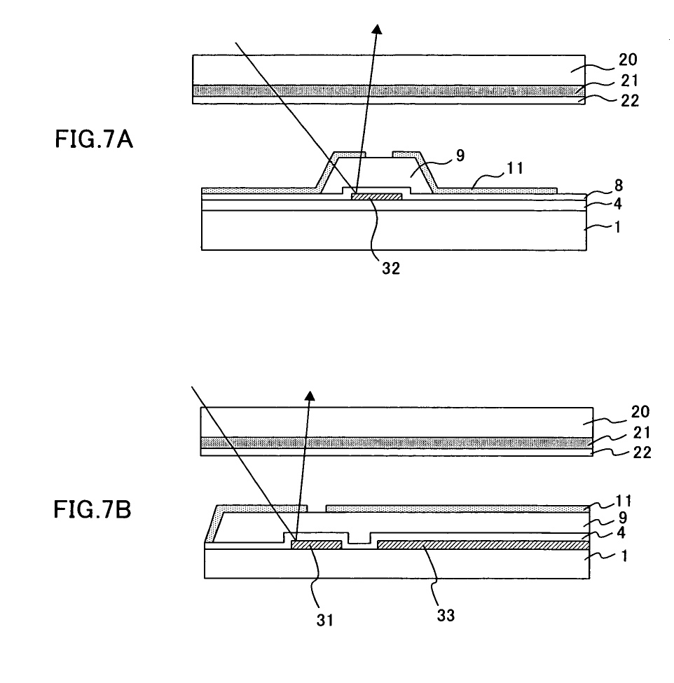

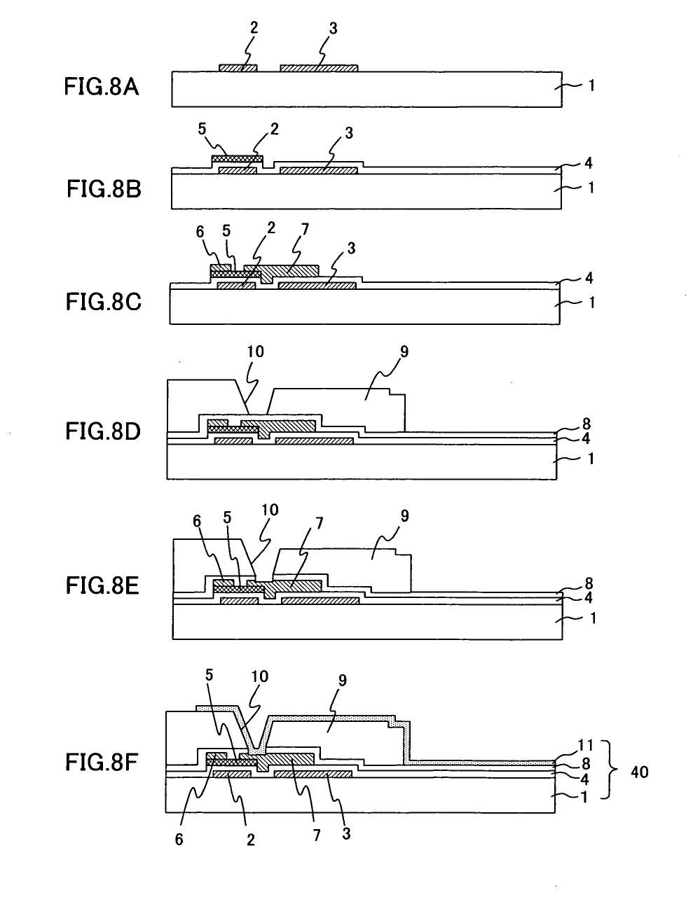

FIG. 5 is a section view showing a semi-transmission type liquid crystal display device of a first embodiment of the present invention, which especially shows a constitution of the semi-transmissions type liquid crystal display device near a TFT. FIG. 6 is a plan view showing a constitution of the semi-transmission type liquid crystal display device of the first embodiment of the present invention. FIGS. 7A and 7B are section views respectively taken along the lines I-I and II-II in FIG. 7. FIGS. 8A to 8F are process diagrams showing a method of manufacturing the semi-transmission type liquid crystal display device.

As described FIG. 5, the semi-transmission type liquid crystal display device of this embodiment comprises an active matrix substrate 40 in which TFTs operating as a switching element are formed, an opposite substrate 50, and a liquid crystal layer 30 interposed between both substrates. The semi-transmission type liquid crystal display device comprises a backlight light source 14 on the rear side of an active matrix substrate 40, phase difference plates (λ/4 plate) 12 and 24 on the outer sides of the active matrix substrate 40 and the opposite substrate 50, and polarization plates 13 and 25 on the outer sides thereof.

The active matrix substrate 40 comprises a pixel region 100 surrounded by each data line 32 and each gate line 31 as shown in FIG. 6. The pixel region 100 is constituted by a reflection area 101 for reflecting external light and a transmission area 102 for transmitting incidence light from the backlight light source 14 therethrough.

The TFT of the active matrix substrate 400 is arranged in the reflection area 101. As shown in FIG. 5, the TFT is constituted by a gate electrode 2, a semiconductor layer 5, a drain electrode 6 connected to the data line 32, and a source electrode 7 having a function of a reflection film. A transparent organic film 9 is formed so as to cover the TFT in the reflection area 101 and to be convex-shaped. The active matrix substrate 40 comprises a transparent electrode film 11 in the transmission area 102, which functions as a pixel electrode. The transparent electrode film 11 is formed so as to cover the transparent organic film 9 and the transmission area 102 of the active matrix substrate 40. The transparent electrode film 11 provided so as to extend onto the transparent organic film 9 in the reflection area 101 is connected to the source electrode 7 through a contact hole 10 from the surface of the transparent organic film 9. On the TFT, a passivation film 8 is formed. Though illustration is omitted, an alignment film is formed on the surface of the transparent electrode film 11. The portion illustrated by the dotted lines of FIG. 6, which is denoted by reference numeral 34, indicates an opening end of the transparent organic film 9.

On the other hand, as shown in FIG. 5, the opposite substrate 50 comprises a transparent insulating substrate 20, a color filter 21, an opposite electrode 22 made of the same material as that of the transparent electrode film 11 (pixel electrode) of the active matrix substrate 40, and an alignment electrode (not shown).

A phase difference plate (λ/4 plate) 24 and a polarization plate 25 are provided on the side opposite to the plane of the opposite substrate 50 which contacts with the liquid crystal. Furthermore, an optical path changing layer 26 is formed on the polarization plate 25. A light scattering layer 23 is provided between the opposite substrate 50 and the phase difference plate 24.

Herein, a storage electrode 3 and the source electrode 7 located below the transparent organic film 9 in the reflection area 101 have also a function to operate as the reflection plate, and should be made of a metal such as Al having a high reflectance. Furthermore, since the storage electrode 3 and the source electrode 7, which operate as the reflection plate, are flat in this embodiment, light incident at an angle of −30° relative to a normal line component of the panel is basically emitted to a direction of 30°. Accordingly, it is impossible to avoid displaying of external light of the light source.

For this reason, the semi-transmission type liquid crystal display device of this embodiment is designed such that the light incident at the angle of −30° is emitted to a direction of 0° by use of the optical path changing layer 26. As the optical path changing layer 26, for example, an optical path changing film manufactured by Sumitomo Chemical Company, Limited can be used. This film has a surface shape like a mountain, and changes an optical path by use of a difference between a refractive index of an air layer and that of the film.

As the light scattering layer 23, a layer obtained by enchasing beads having different refractory indexes into transparent resin, for example, can be used. The light is diffusely reflected by the light scattering layer 23, and its bundle of rays can be widened. In this embodiment, though the optical path changing layer 26 is used in order to prevent the displaying of external light, it is possible to prevent the displaying of external light by the light scattering layer alone to some extent. A touch panel is mounted on the semi-transmission type liquid crystal panel in some cases, and by forming the touch panel so as to have a flat surface shape, it is possible to allow the touch panel to have the function as the optical path changing layer 26.

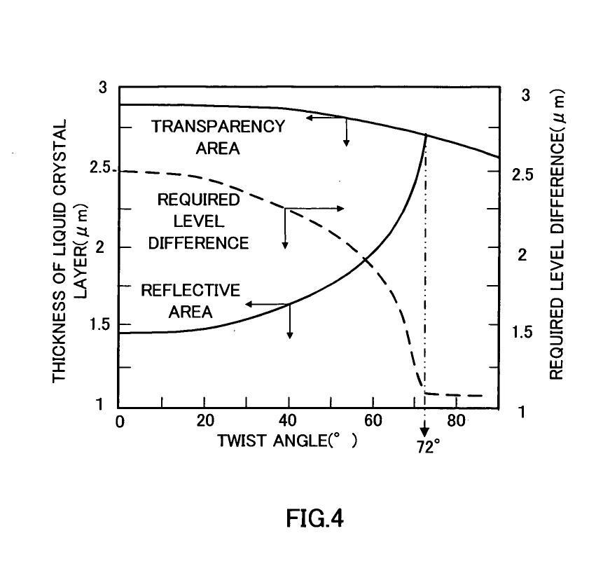

An average height of the transparent organic film 9 is set to be equal to a difference between a gap DF (a height of the liquid crystal layer) of the transmission area of the semi-transmission type liquid crystal device and a gap DR (a thickness of the liquid crystal layer) of the reflection area thereof. When an anisotropy Δn of a refractory index of the liquid crystal is 0.083, an optimal gap DF of the transmission area and an optimal gap DR of the reflection area are determined by the relationship diagram shown in FIG. 4. Accordingly, when the semi-transmission type liquid crystal display device is designed with the twist angle of 0°, the gap DF of the transmission area should be near 2.8 μm and the gap DR of the reflection area should be near 1.4 μm. Accordingly, the step difference of the transparent organic film is 1.4 μm.

As shown in FIGS. 7A and 7B, the transparent organic film 9 is provided also on the gate line 31 and the data line 32. Then, the transparent electrode film 11 made of ITO or the like, which is the pixel electrode, is provided on the transparent organic film 9. The thickness of the transparent organic film 9 is made as large as 1 to 3 μm, and the capacitance value between the pixel electrode and the wiring can be fully made small. Therefore, it is possible to superpose the pixel electrode on the data line 32 and the gate line 31. As described above, by superposing the pixel electrode on the data line 32 and the gate line 31, shielding of unnecessary leakage light around the data line 32 and the gate line 31 is performed. As a result, a black matrix for shielding the unnecessary leakage light around the wiring needs not be provided on the opposite substrate 50, and an aperture rate can be increased. Since an area where the pixel electrode and the wiring are superposed functions as the reflection area, it is possible to utilize this area as the reflection area effectively. In the pixel electrode, the reflection area and the transmission area are made of ITO, which are made of the same material as that of the opposite electrode 50. Therefore, the residual DC voltage which allows electrons to remain in the alignment film alone made of polyimide or the like on the reflection area never occurs unlike in the case of the conventional semi-transmission type liquid crystal display device, and the problem of flickering never arises.

Next, referring to FIGS. 8A to 8F, a method of manufacturing the semi-transmission type liquid crystal display device of this embodiment will be described in the order of manufacturing processes. First, as shown in FIG. 8A, a metallic film made of Al—Nd, Cr or the like is deposited on the entire surface of the transparent insulating substrate 1 made of glass or the like. Subsequently, this metallic film is patterned, and the gate line (not shown), the gate electrode 2, the storage electrode 3, a common storage line 33 (not shown) and an auxiliary capacity electrode (not shown) are formed (First Photolithography Process, hereinafter referred to as First PR). Note that the constituent components (not shown in FIG. 8A) are illustrated in FIG. 5 and FIG. 6.

Subsequently, as shown in FIG. 8B, the gate insulating film 4 made of a material such as SiO₂, SiNₓ and SiOₓ is formed on the entire surface of the resultant structure, and thereafter the semiconductor film such as a-Si is formed on the entire surface of the resultant structure by a Plasma Chemical Vapor Deposition method or the like. This semiconductor film is patterned, and thus the semiconductor layer 5 is formed (Second PR).

Next, as shown in FIG. 8C, a metal such as Al—Nd, Cr is deposited on the entire surface of the resultant structure, and then patterned. Thus, the data line 32 (not shown), the drain electrode 6, and the source electrode 7 are formed (Third PR). By the above described processes, the thin film transistor (TFT) is fabricated. Thereafter, as shown in FIG. 8D, the passivation film formed of a SiNₓ film or the like is deposited on the entire surface of the resultant structure, and the TFT is protected. Herein, in order to cause the auxiliary capacity film, the source electrode 7, the data line 32, and the gate line 31 to function also as the reflection film, metals having a high reflectance, for example, Al, Al alloy, Ag, and Ag alloy should be contained in a reflection plane thereof. The reflection metal layer may be a single film or alloys, or a lamination film composed of two or more layers selected out of these metals.

Next, as shown in FIG. 8E, an organic film made of photosensitive acrylic resin, for example, PC 403 manufactured by JSR, is coated onto the passivation film 8 of the pixel electrode 100 by a spin coating method. This organic film is exposed and developed, and the pattern of the transparent organic film 9 and the contact hole 10 are formed on the TFT portion (Fourth PR). The development of the photosensitive acrylic resin uses alkali developing solution. Next, an opening is formed in the passivation film 8, and thus the contact hole for connecting the pixel electrode and the TFT is opened (Fifth PR).

As shown in FIG. 8F, after a transparent conductive film such as ITO is deposited on the entire surface of the resultant structure by a sputtering method, the transparent conductive film is etched by use of a resist pattern, and the transparent electrode film 11 covering the entire of the respective pixels is formed (Sixth PR). Thereafter, the alignment film (not shown) made of polyimide is formed on the transparent electrode film 11, and the fabrication of the active matrix substrate 40 is completed. Next, although illustrations are omitted (see FIG. 5), the opposite substrate 50, which is completed by sequentially forming the color filter 21, the opposite electrode 22, the alignment film made of polyimide, and the like on the transparent insulating substrate 20, is prepared. The opposite electrode 22 is made of the same material as that of the transparent electrode film 11 of the active matrix substrate 40. Then, the liquid crystal layer 30 is interposed between both substrates. The phase difference plate (λ/4 plate) 12 and the polarization plate 13 are disposed on the side of the active matrix substrate 40 which does not face the liquid crystal layer 30, and the phase difference plate (λ/4 plate) 24 and the polarization plate 25 are disposed on the side of the opposite substrate 50 which does not face the liquid crystal layer 30. The backlight light source 14 is disposed on the back plane of the polarization plate 13, the front of which faces the active matrix substrate 40, whereby the semi-transmission type liquid crystal display device is fabricated.

As described above, in the fabrication of the active matrix substrate of the semi-transmission type liquid crystal display device of this embodiment according to the present invention, the photolithography processes are performed six times (6 PR) The active matrix substrate of the present invention can shorten the manufacturing process, and reduce the manufacturing costs compared to the fabrication of the active matrix substrate of the conventional semi-transmission type liquid crystal display device, in which the photolithography processes are performed seven times (7 PR).

### Second Embodiment

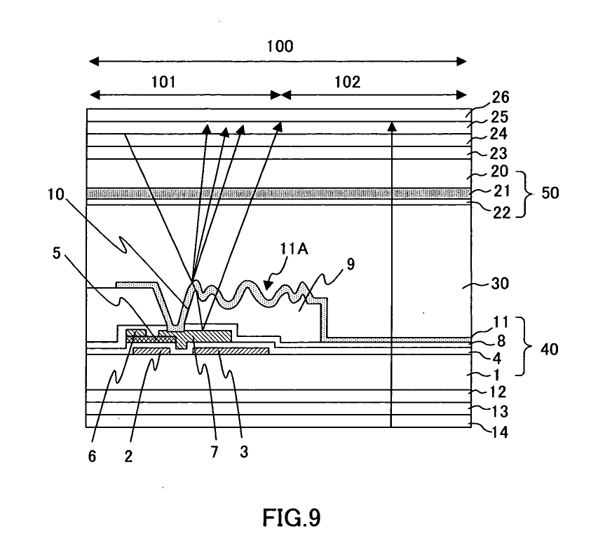

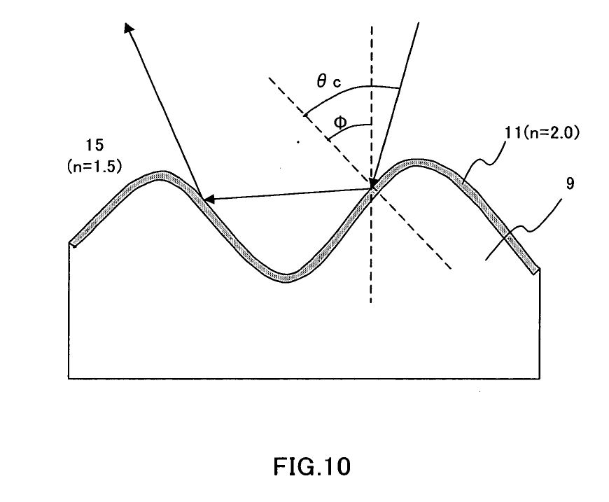

FIG. 9 is a plan view showing a constitution of a semi-transmission type liquid crystal display device which is a second embodiment of the present invention. The constitution of the semi-transmission type liquid crystal display device of this embodiment largely differs from that of the semi-transmission type liquid crystal display device of the first embodiment in that a random concavo-convex surface 11A is provided on a front face of the transparent organic film 9. FIG. 10 is an enlarged view of the transparent organic film portion having the concavo-convex surface 11A. The transparent electrode film 11 provided on the transparent organic film 9 in the reflection area, which is formed to be convex-shaped, is generally an ITO film, and its refractory index n1 is equal to about 2.0. On the other hand, the refractory index n2 of the polyimide film of the alignment film 15 on the transparent electrode film 11 and the liquid crystal layer 30 are equal to about 1.5. When an angle θc of inclination of the irregularity plane when viewed from the incidence light is equal to about 48.6° or more, which is a critical angle obtained from sine θc=(n2/n1)=0.75, light is reflected on the transparent electrode film 11 (ITO film). In FIG. 10, when the angle θc of inclination of the irregularity plane is, for example, 20° the light incident onto the transparent electrode film 11 with the twist angle Φ of −30° is totally reflected on the surface thereof. When a certain degree of an inclination angle distribution is provided by making the angle of inclination of the irregularity plane equal to an average angle of inclination (θc−Φ=20°), a part of the incidence light is reflected on the surface of the ITO film having the irregularity shape. In addition, since an incidence angle and an emission angle differ from each other, the displaying of external light never occurs. In this case, controls of the convex pattern of the transparent organic film and the shape of the irregularity plane thereof are important to control the emission angle.

Next, a method of manufacturing the semi-transmission type liquid crystal display device of this embodiment will be described in the order of manufacturing processes. Descriptions are omitted because this embodiment is the same as the first embodiment other than the formation of the irregularity plane of the transparent organic film. In the formation processes of the irregularity plane 11A of the transparent organic film, photosensitive acrylic resin is first coated. With reference to exposure of the photosensitive acrylic resin, the convex portion of the irregularity plane is kept unexposed, and the concave portion of the irregularity plane is exposed with a comparatively small amount of light. Furthermore, an area where the contact hole is formed is exposed with a comparatively large amount of light. In order to perform such an exposure, a halftone (gray-tone) mask may be used. By use of the halftone mask, it is possible to form the irregularity plane 11A and the contact hole 10 in the surface of the transparent organic film 9 by one exposure process. Note that the ordinary irregularity plane 11A and the contact hole 10 can be formed also by use of an ordinary mask.

Furthermore, a method of forming another irregularity plane will be described. First, an original production master having a fine irregularity plane on its surface is prepared from a metallic plate. This original production master is pressed against a surface of a photosensitive acrylic sheet, and an irregularity shape thereof is printed on the photosensitive acrylic sheet. The photosensitive acrylic sheet having the irregularity shape is adhered to the active matrix substrate, and an acrylic resin film is formed on the active matrix substrate. Next, the contact hole is formed in the photosensitive acrylic resin film by a photolithography method. Unnecessary portions of the acrylic resin film are removed by a developing process. Thereafter, the acrylic resin film left on the substrate is fired, and hardened.

In the method of adhering the photosensitive acrylic sheet having the irregularity shape to the active matrix substrate, the irregularity plane having an objective angle of inclination can be comparatively stably formed, and control of a reflection characteristic of the irregularity plane becomes easier.

### Third Embodiment

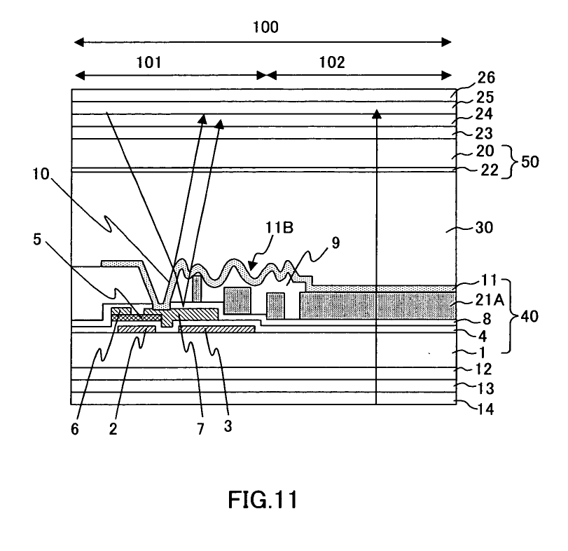

FIG. 11 is a section view showing a constitution of a semi-transmission type liquid crystal display device of a third embodiment according to the present invention. The constitution of the semi-transmission type liquid crystal display device of this embodiment differs largely from that of the semi-transmission type liquid crystal display devices of the first and second embodiments in that a color filter is provided on the active matrix substrate 40 side. As shown in FIG. 11, the semi-transmission type liquid crystal display device of this embodiment comprises an active matrix substrate 40 in which TFTs are formed, an opposite substrate 50, and a liquid crystal layer 30 interposed between both substrates. A backlight light source 14 is disposed on the back side of the active matrix substrate 40 which does not face the liquid crystal layer 30. A phase difference plate (λ/4 plate) 12 and a polarization plate 13 are disposed on the side of the active matrix substrate 40 which does not face the liquid crystal layer 30, and a phase difference plate (λ/4 plate) 24 and a polarization plate 25 are disposed on the side of the opposite substrate 50 which does not face the liquid crystal layer 30. Note that other reference numerals of FIG. 11, which are the same as those of FIG. 9, represent the same constituent components as those of FIG. 9.

The active matrix substrate 40 comprises a pixel region 100 surrounded by each data line 32 and each gate line 31. The pixel region 100 is constituted by a reflection area 101 for reflecting external light and a transmission area 102 for transmitting incidence light from the backlight light source 14 therethrough.

The TFT of the active matrix substrate 40 is arranged in the reflection area 101. The TFT is constituted by a gate electrode 2, a semiconductor layer 5, a drain electrode 6 connected to the data line 32, and a source electrode 7 having a function of a reflection film. A transparent organic film 9 is formed so as to cover the TFT in the reflection area 101 and to be convex-shaped. The active matrix substrate 40 comprises a transparent electrode film 11 in the transmission area 102, which functions as a pixel electrode. The transparent electrode film 11 is formed so as to cover the transparent organic film 9 and the transmission area 102 of the active matrix substrate 40. The transparent electrode film 11 provided so as to extend onto the transparent organic film 9 in the reflection area 101 is connected to the source electrode 7 through a contact hole 10 from the surface of the transparent organic film 9. On the TFT, a passivation film 8 is formed. Though illustration is omitted, an alignment film is formed on the surface of the transparent electrode film 11.

In the reflection area 101, a color filter 21A randomly patterned to be minutely convex-shaped is provided on the passivation film 8. The patterned color filter 21A may have an isolated dotted shape or a shape in the form of a line as shown in FIG. 11. On the passivation film 8, the color filter 21A is provided in the form of a line so as to reach the gate line and the data line. The color filter 21A in the transmission area 102 is not patterned minutely unlike in the case of that in the reflection area 101. The reason why the reflection area 101 alone is minutely patterned is that the reflection area 101 is used as a base for forming the irregularity plane after the transparent organic film is coated onto the color filter 21A. While transmission light passes through the color filter 21A just once, reflection light passes therethrough twice. By patterning the reflection area 101 alone minutely, it is possible to prevent an extreme decrease in reflectance and an extreme color discrepancy between the transmission area 102 and the reflection area 101. Furthermore, the transparent organic film 9 is provided on the color filter 21A in the reflection area 101. As in the case of the second embodiment, the surface of the transparent organic film 9 in the reflection area 101 has the concavo-convex surface 11B having a predetermined inclination angle distribution. To adjust the step difference from the reflection area 101, the transparent organic film 9 is not provided in the transmission area 102. As in the case of the second embodiment, the average height of the irregularities of the irregularity plane 11B is set so that it is equal to a difference between the gap DF of the transmission area of the semi-transmission type liquid crystal display device and the gap DR of the reflection area thereof. The transparent pixel electrode, that is, the transparent electrode film 11, is connected to the source electrode 7 through the contact hole 10, and plays a role as a common pixel electrode for driving the liquid crystal in the reflection and transmission areas.

On the other hand, the opposite substrate 50 comprises a transparent insulating substrate 20, an opposite electrode 22 made of the same material (ITO or the like) as the transparent electrode film 11 of the active matrix substrate 40, and an alignment film (not shown). The opposite electrode 22 is made of the same material (ITO or the like) as the transparent electrode film 11 of the active matrix substrate 40.

A method of manufacturing the semi-transmission type liquid crystal display device of this embodiment is the same as the second embodiment except that the color filter layer 21A is formed, and the transparent organic film 9 needs not be subjected to a half exposure process. Accordingly, descriptions for the method of manufacturing the semi-transmission type liquid crystal display device of this embodiment are omitted. Note that the color filter layer 21A may be formed by a photolithography method, or alternatively may be formed by a printing method.

The features of this embodiment is that the color filter 21A minutely and randomly patterned to be convex-shaped is provided on the passivation film 8. The transparent organic film 9 having the irregularity plane can be formed by coating the acrylic resin or the like for forming the transparent organic film 9, which may be either an ultraviolet curing type or a thermal polymerization type, onto the base of the color filter 21A and curing it. By forming the ITO film on the irregularity plane of the transparent organic film 9, the irregularity plane 11b of the transparent electrode film 11 having the predetermined angle of inclination can be formed. The irregularity plane 11b of this ITO film can be used as a lens.

While this invention has been described in connection with certain preferred embodiments, it is to be understood that the subject matter encompassed by way of this invention is not limited to those specific embodiments. On the contrary, it is intended for the subject matter of the invention to include all alternative, modification and equivalents as can be included within the spirit and scope of the following claims.

1. A semi-transmission type liquid crystal display device, comprising:
a first substrate which includes a first insulating substrate, a plurality of data lines and a plurality of gate lines intersecting with each other on the first insulating substrate, and a switching element disposed near each of intersection points of the data lines and the gate lines, the first substrate further including a reflection area having a reflection film, in which the switching element is arranged, in each pixel region surrounded by the data lines and the gate lines, and a transmission area having a first transparent electrode film in each pixel region;
a second substrate having a second insulating substrate, the second substrate being arranged opposite to the first substrate; and
a liquid crystal layer arranged between the first substrate and the second substrate,
wherein in the reflection area, a transparent organic film is formed to be convex-shaped so as to cover the switching element; in the transmission area, a first transparent electrode film functioning as a pixel electrode is formed, the first transparent electrode film being provided so as to extend onto the transparent organic film in the reflection area, and connected to one electrode of the switching element through a contact hole from a surface of the transparent organic film; and a second transparent electrode film functioning as an opposite electrode, which is made of the same material as that of the first transparent electrode film, is formed on the second insulating substrate.

2. The semi-transmission type liquid crystal display device according to claim 1, wherein the first substrate further includes a color filter layer under the first transparent electrode film.

3. The semi-transmission type liquid crystal display device according to claim 1, wherein the first substrate further includes a color filter layer in the transparent organic film in the reflection area, the color filter layer being patterned so as to have a shape in the form of a line or a dotted shape.

4. The semi-transmission type liquid crystal display device according to claim 1, wherein a source electrode and a drain electrode of the thin film transistor contains one metal selected out of Al, Al alloy, Ag and Ag alloy in a surface thereof.

5. The semi-transmission type liquid crystal display device according to claim 1, wherein a phase difference plate and a polarization plate are arranged respectively on sides of surfaces of the first substrate and the second substrate in this order, which do not face the liquid crystal layer.

6. The semi-transmission type liquid crystal display device according to claim 5, wherein a light scattering layer is provided between the second substrate and the phase difference plate provided on the side of the surface of the second substrate.

7. The semi-transmission type liquid crystal display device according to claim 5, wherein an optical path changing layer is provided outside the polarization plate on the side of the second substrate.

8. The semi-transmission type liquid crystal display device according to claim 1, wherein the transparent organic film is provided also on the data lines and the gate lines so as to cover the data lines and the gate lines, and the first transparent electrode film is provided on the transparent organic film on the data lines and the gate lines so as to be superposed on the data lines and the gate lines.

9. The semi-transmission type liquid crystal display device according to claim 1, wherein the transparent organic film is acrylic resin.

10. The semi-transmission type liquid crystal display device according to claim 1, wherein an irregularity plane is formed in a surface of the transparent organic film so that a surface of the first transparent electrode film formed on the transparent organic film has a reflection function to totally reflect light incident thereonto.

11. A method of manufacturing a semi-transmission type liquid crystal display device comprising:
a first substrate which includes a plurality of gate lines and a plurality of data lines intersecting with each other, and a thin film transistor disposed near each of intersection points of the data lines and the gate lines, the first substrate further including a reflection area having a reflection film, in which the thin film transistor is arranged in each pixel region surrounded by the data lines and the gate lines, and a transmission area having a first transparent electrode film;
a second substrate having a second insulating substrate, the second substrate being arranged opposite to the first substrate; and
a liquid crystal layer arranged between the first substrate and the second substrate,
wherein a source electrode of the thin film transistor is formed so that the source electrode serves also as the reflection film; the first transparent electrode film and the second transparent electrode film are made of the same material; a convex-shaped transparent organic film having a contact hole connected to the source electrode on the thin film transistor of the reflection area is patterned; and the first transparent electrode film is patterned in the transmission area and, at the same time, the first transparent electrode film is formed so as to extend onto the transparent organic film to be electrically connected to the source electrode through the contact hole.

12. The method of manufacturing a semi-transmission type liquid crystal display device according to claim 11, wherein the source electrode contains one metal selected out of Al, Al alloy, Ag, and Ag alloy.

13. The method of manufacturing a semi-transmission type liquid crystal display device according to claim 11, wherein when the first transparent electrode film is patterned in the transmission area and the reflection area, patterning is carried out so that the first transparent electrode film is superposed on the gate lines and the data lines around each of the pixels.

14. The method of manufacturing a semi-transmission type liquid crystal display device according to claim 11, wherein when the convex-shaped transparent organic film having the contact hole connected to the source electrode on the thin film transistor of the reflection area is formed, a concavo-convex surface having a predetermined angle of inclination is formed on a front face of the transparent organic film so that the first transparent electrode film formed on the surface of the transparent organic film has a reflection function to totally reflect light incident thereonto.

15. The method of manufacturing a semi-transmission type liquid crystal display device according to claim 11, wherein the transparent organic film is made of acrylic resin.

16. The method of manufacturing a semi-transmission type liquid crystal display device according to claim 11, wherein a color filter layer is formed under the first transparent electrode film of the first substrate.

17. The method of manufacturing a semi-transmission type liquid crystal display device according to claim 14, wherein a passivation film is formed on the entire surface of the transparent insulating substrate including the thin film transistor; the color filter layer is patterned on the passivation film of the reflection area so as to have a shape in the form of a line or a dotted shape; the transparent organic film is coated so as to cover the color filter, and patterned; and the transparent organic film having the concavo-convex surface with a predetermined angle of inclination is formed.

18. The method of manufacturing a semi-transmission type liquid crystal display device according to claim 11, wherein phase difference plates are arranged on planes of the first substrate and the second substrate opposite to planes thereof sandwiching the liquid crystal layer, and polarization plate are arranged respectively on the phase difference plates.

19. The method of manufacturing a semi-transmission type liquid crystal display device according to claim 18, wherein a light scattering layer is formed between the second substrate and the phase difference layer.

20. The method of manufacturing a semi-transmission type liquid crystal display device according to claim 18, wherein an optical path changing layer is formed outside the polarization plate of the second substrate.
